(19) United States
(12) Patent Application Publication
(10) Pub. No.: US 2026/0238111 A1
(43) Pub. Date: Aug. 13, 2026

(54) DC CONVERTER WITH ACTIVE CLAMPING

(71) Applicant: Vladimir Anatolyevich POLIKARPOV, Moscow (RU)

(72) Inventors: Vladimir Anatolyevich POLIKARPOV, Moscow (RU); Anatoliy Grigoryevich POLIKARPOV, Moscow (RU)

(21) Appl. No.: 19/474,985

(22) PCT Filed: Apr. 10, 2024
(86) PCT No.: PCT/RU2024/000124

§ 371 Date: Oct. 13, 2025

(30) Foreign Application Priority Data
Apr. 12, 2023 (RU) 2023109151

(51) Int. Cl. H02M 1/00; H02M 3/335

(52) U.S. Cl. CPC H02M 1/0058; H02M 3/33569

(57) ABSTRACT

A DC converter with active clamping comprises a transformer having one secondary winding that is connected via a series connected diode to a filter capacitor, and another secondary winding that is coupled by the end thereof to the beginning of the first secondary winding and is connected via a series-connected diode to an input of an L-type LC filter, an output capacitor of which is connected in series to the aforesaid filter capacitor. The input of the L-type LC filter is connected via a bypass diode to the common connection point of the capacitors of the filters, and a load is connected in parallel to said capacitors. The technical result is a decrease in dynamic losses.

The invention relates to electrical engineering, in particular to single-ended DC voltage converters, and can be used in secondary power supply systems to convert, regulate and stabilize the DC output voltage that is galvanically isolated from the DC input voltage and to reduce dynamic losses.

There are known DC voltage converters with active clamping [1].

The disadvantage of the known DC voltage converter with active clamping is the absence of the possibility of switching the power switch to the zero current value, which leads to an increase in dynamic losses in the power switch when it is turned on, as well as the trapezoidal shape of the current through the power switch, which leads to an additional losses in the power switch in the conductive state and dynamic losses when it is turned off.

The closest technical solution to the proposed device is a DC voltage converter with active clamping is given in [1], containing the primary winding of the transformer, connected through a controlled power switch to the terminals of the input DC voltage source, parallel to which a clamping element is connected, composed of a series-connected capacitor and an additional switch, a transformer performing electrical isolation and obtaining the required level of constant output voltage, secondary windings connected through rectifier diodes to the input of the LC filter, to the output of which the load is connected.

The object of the invention is to overcome these disadvantages.

This objective is accomplished by the fact that in a DC voltage converter with active clamping, the primary winding of the transformer of which is connected through a power switch to the terminals of the input DC voltage source, parallel to which the clamping element is connected, and the two secondary windings of the transformer operate simultaneously on the time interval of the on state of the power switch, wherein the first of them through the rectifier diode is connected to the first filter capacitor, and the second, through the rectifier diode is connected to the input of the LC filter, the output capacitor of which is connected in series with the first filter capacitor, parallel to which the load is connected, and the input of the LC filter through the shunt rectifier diode is connected to the common connection point of the filter capacitors, parallel to which the load is connected.

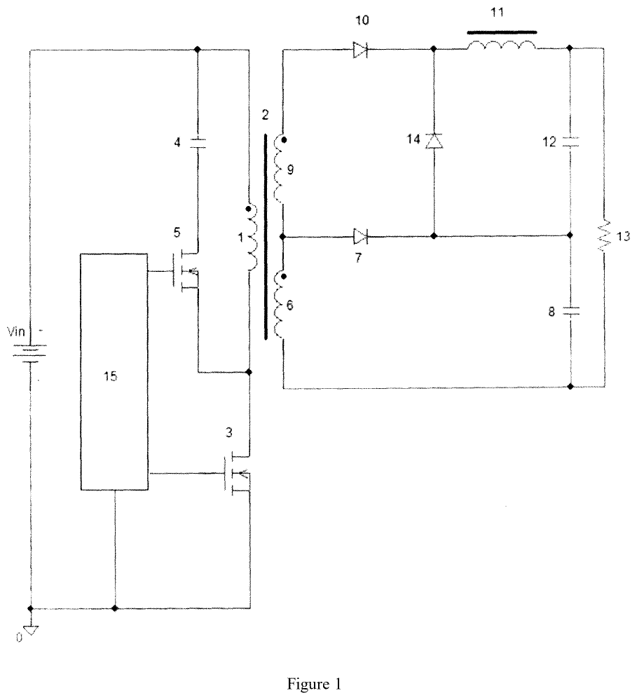

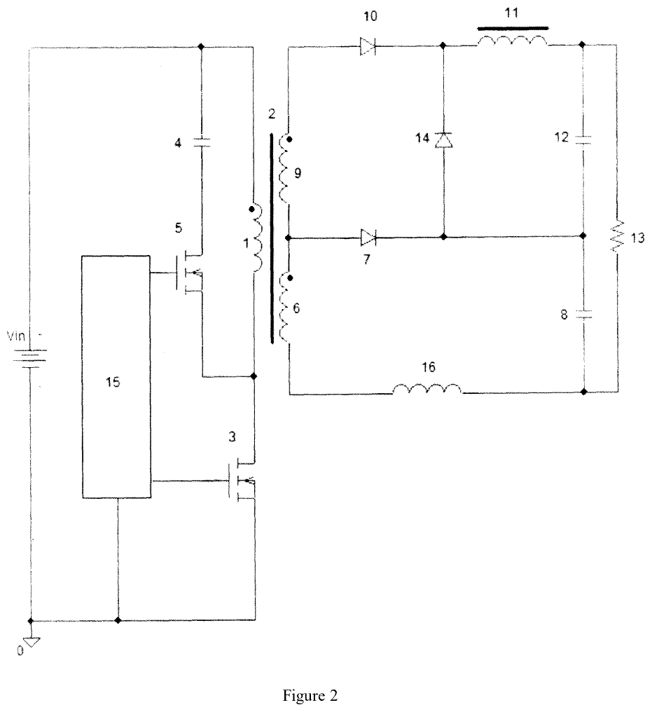

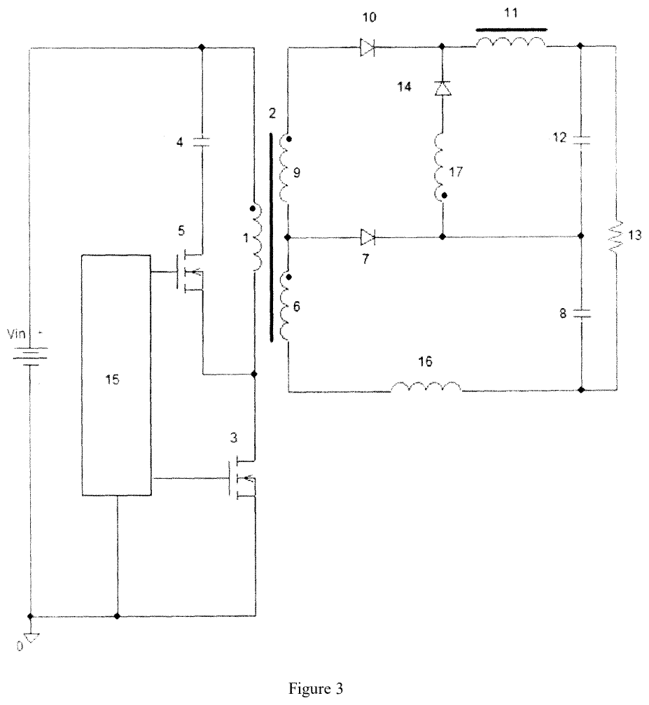

FIGS. 1, 2 and 3 illustrate the schematic diagrams of the proposed DC-DC active clamp converter. FIG. 1 depicts a schematic diagram of a DC-DC active clamp converter; FIG. 2 depicts a schematic diagram of a DC-DC active clamp converter with low linear inductance. FIG. 3 depicts a schematic diagram of a DC-DC active clamp converter with the introduction of an additional third of the secondary coil.

In FIG. 1 the beginning of the primary winding 1 of the transformer 2 is connected to the positive pole of the input DC voltage source, and the end of the primary winding 1, through a power switch 3, implemented in the form of a MOSFET field-effect transistor, is connected to the negative pole of the input DC voltage source. A clamping element is connected in parallel to the primary winding 1 of the transformer 2, consisting of a series-connected capacitor 4 and an additional switch 5, implemented in the form of a MOSFET field-effect transistor. The anode of the rectifier diode 7 is connected to the beginning of the secondary winding 6 of the transformer 2, the cathode of which is connected to one of the terminals of the capacitor 8, the second terminal of which is connected to the end of the winding 6. The beginning of winding 6 is connected to the end of winding 9, the beginning of which is connected to the anode of diode 10, the cathode of which is connected to inductance 11 of the LC filter, the second terminal of which is connected to capacitor 12, which is the output capacitor of the LC filter, connected in series with capacitor 8, in parallel to which load 13 is connected. The cathode of the shunt diode 14 is connected to the common connection point of the inductor 11 and the rectifier diode 10, the anode of which is connected to the common connection point of the capacitors 8, 12. The control electrodes of switches 3, 5 are connected to the pulse-width controller 15.

The operation of the proposed DC-DC active clamp converter is based on the preposition of the ideality of switch elements, the steady-state mode of operation and the continuity of the change in the magnetic flux in the core of the transformer 2.

Let us denote by D the duration of the switched-on state of the switch 3 relative to the period T. In this case, at the stage of the closed state DT of the switch 3, energy is transferred to the load through a forward-biased rectifier diode 7 and a secondary winding 6. In this case, due to the balance of charges in the time intervals DT and (1-D), a current I_{L}/D flows through the rectifier diode 7 of capacitor 8, where I_{L} is the load current, and the voltage across capacitor 8 is determined by the expression n₁V_{IN}, where n₁ is the ratio of the turns of winding 6 to winding 1.

However, simultaneously with the transfer of energy to the load via the secondary winding 6 and the diode 7, energy is transferred to the load during this period of time and via the secondary winding 9 and a forward-biased diode 10 to the input of the LC filter, the output capacitor 12 of which is connected in series with the capacitor 8. As a result of this transfer of energy to the load a voltage equal to n₂V_{IN}D is formed on capacitor 12, where n₂ is the ratio of turns of winding 9 to winding 1.

Due to the simultaneous transfer of energy to the load through both secondary windings 6 and 9 of transformer 2, a difference current (I_{L}/D−I_{L}) flows through diode 7, which is the value of the current I_{L}(1-D)/D, which is significantly less than I_{L}/D and, as a result, losses are less in diode 7 and voltage ripple are less in capacitor 8. The output voltage (n₁V_{IN}+n₂V_{IN}D) is equal to the sum of the voltages across capacitors 8, 12.

After turning off the switch 3, the additional switch 5 of the clamping element is switched on and the voltage on the winding 1 of transformer 2 is fixed at the voltage level on capacitor 4 equal to V_{IN}D/(1-D). Due to the voltage reversal on all windings of transformer 2 and the voltage fixation on the primary winding 1 of transformer 2, the rectifier diodes 7, 10 are locked, and the shunt diode 14 turns on and switches the inductance current 11 to itself. Simultaneously with this process, the magnetization current of transformer 2 is switched to the switched-on additional switch 5 and capacitor 4, which make up the clamping element.

When energy is transferred to the output circuit in the time interval DT of the switched-on state of the switch 3, two processes occur: one of which is associated with simultaneous magnetization of the transformer 2 along the primary winding 1 from the input voltage source V_{IN} and along the secondary winding 6 from the voltage n₁V_{IN} on the capacitor 8. As a result of these magnetizations, the currents increase linearly proportionally. In the secondary winding 6, an increase in this current leads to a decrease in current through the rectifier diode 7, which is in a conductive state during this time interval. The linear decrease in current through the rectifier diode 7 is transformed into the primary winding 1 and compensates for the linear increase in current through the primary winding 1, which leads to a rectangular shape of the current through the power switch 3.

The second process is associated with the moment when the power switch 3 is turned on. When the power switch 3 is turned on and the additional switch 5 of the clamping element is turned off, the voltages on the transformer windings 2 are reversed and the rectifier diode 7 is turned on. However, the rectifier diode 7 is turned on with a time delay relative to the moment when the power switch 3 is turned on. This delay is due to the final the time of the voltage change across the windings of transformer 2 and the positive potential at the cathode of rectifier diode 7 equal to n₁V_{IN}.

A temporary delay in the transfer of energy to the output circuit when the power switch 3 is turned on leads to a separation of the current and voltage fronts on the power switch 3 and a decrease in dynamic losses when it is turned on.

The introduction of a small linear inductance 16 (FIG. 2), amounting to nanohenry, in series with the secondary winding 6 enhances the effect of forming a zero current value through the power switch 3 when it is turned on.

The introduction of an additional third of the secondary winding 17 (FIG. 3), connected at the beginning to the common connection point of capacitors 8, 12, and at the end to the anode of the shunt diode 14, the cathode of which is connected to the common connection point of diode 10 and inductance 11, allows to expand the control range to (n₁V_{IN}+(n₂+n₃)V_{IN}D), where n₃ is the ratio of the turns of winding 17 to winding 1.

As noted above, the current through the power switch 3 is rectangular form, which reduces losses on the power switch 3 when it is turned off, since the switch is turned off for less current.

Thus, the proposed DC voltage converter with active clamping, in comparison with the known device, allows you to generate a constant output voltage from a constant input voltage with a decrease in dynamic losses, making it possible to turn on the power switch to zero current and, as a result, reduce dynamic losses in the power switch when it is switching on and due to the squareness of the current in the conductive state when switching off.
1. [USSR Patent No. 892614 H02M 3/335 “Single-ended constant voltage regulator” AG Polikarpov, EF Sergienko].

1. A DC voltage converter with active clamping, comprising a transformer having a primary winding connected via a power switch to the terminals of a constant input voltage source, in parallel with which a clamping element consisting of a series-connected capacitor and an additional switch is connected, secondary windings with rectifier diodes connected to an LC filter, characterized in that the first secondary winding of the transformer is connected to the first filter capacitor through a series-connected diode, the second secondary winding of the transformer, connected at the end to the beginning of the first, is connected through a series-connected diode to the input of an LC filter, the output capacitor of which is connected in series with the first filter capacitor, and the input of the LC filter is connected through a shunt diode to a common connection point of the filter capacitors, in parallel to which the load is connected.

2. The DC voltage converter with active clamping according to claim 1, characterized in that a linear inductance is connected in series with the first secondary winding of the transformer.

3. The DC voltage converter with active clamping according to claim 1, characterized in that a third secondary winding of the transformer is introduced into it, connected with its end to the anode of the shunt diode, and with its beginning to the common connection point of the capacitors, in parallel to which the load is connected.
